(19) United States
(12) Patent Application Publication
(10) Pub. No.: US 2007/0162478 A1
(43) Pub. Date: Jul. 12, 2007

(54) Method of achieving service configurability within telecommunication devices

(75) Inventors: Michael D. Hall, Carrollton, TX (US); Anil K. Kandregula, Richardson, TX (US); Scott Fang, Plano, TX (US)

Correspondence Address: CONLEY ROSE, P.C., 5700 GRANITE PARKWAY, SUITE 330, PLANO, TX, 75024, US

(73) Assignee: Samsung Electronics Co., Ltd.

(21) Appl. No.: 11/326,836

(22) Filed: Jan. 6, 2006

(51) Int. Cl. G06F 17/30; G06F 7/00

(52) U.S. Cl. 707/101; 707/10

(57) ABSTRACT

A telecommunications network element is provided that includes a plurality of software components configured to communicate with one another in a service-oriented architecture. In another embodiment, a network element is provided that includes a service provider that is operable to provide a service and to send a register message to register the service. The register message includes a service provided by the service provider and an identifier used to communicate with the service provider to invoke the service. The network element also includes a service registry and service client. The service registry is operable to receive and store and register message from the service provider. The service client is operable to send a find message to locate the identifier of the service provider in the service registry and to send an invoke message to invoke the service of the service provider.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure relates to telecommunications devices. More specifically, but not by way of limitation, a method and system are provided that promote service configurability in network elements in a telecommunications network.

### BACKGROUND OF THE INVENTION

The components in a telecommunications network are typically referred to as network elements. Examples of network elements include a mobile switching center, a base station, a radio station, a controller, an access point, a core switch, a gateway, and a mobile station or handset. A data packet transmitted by a first handset might pass through a series of other network elements before reaching a second handset.

Within a network element, software components may be present that provide services to other software components, where a service can be defined as a self-contained, well-defined software entity that provides a functionality for the benefit of another software entity but that does not depend on the context or state of other software entities. Examples of services that might be present in a network element include operational measurement monitoring, operational measurement threshold determination, operational measurement data upload, alarm reporting, alarm history retrieval, alarm profile updates, alarm inhibition, configuration data retrieval, configuration data update, billing, software process control, task scheduling, software upgrades, logging, event handling, user authentication, security logging, and access control.

### SUMMARY OF THE INVENTION

In one embodiment, a telecommunications network element is provided that includes a plurality of software components configured to communicate with one another in a service-oriented architecture. In another embodiment, a network element is provided that includes a service provider that is operable to provide a service and to send a register message to register the service. The register message includes a service provided by the service provider and an identifier used to communicate with the service provider to invoke the service. The network element also includes a service registry and service client. The service registry is operable to receive and store and register message from the service provider. The service client is operable to send a find message to locate the identifier of the service provider in the service registry and to send an invoke message to invoke the service of the service provider.

In another embodiment, a method for invoking a service on a network element is provided. The method includes a service provider on the network element informing a service registry on the network element of a service provided by the service provider and a location for communication with the service provider. The method includes a service client on the network element obtaining the location of the service provider in the service registry. The method includes the service client invoking a service provided by the service provider using the location of the service provider found in the service registry.

These and other features and advantages will be more clearly understood from the following detailed description taken in conjunction with the accompanying drawings and claims.

### BRIEF DESCRIPTION OF THE DRAWINGS

For a more complete understanding of the presentation and the advantages thereof, reference is now made to the following brief description, taken in connection with the accompanying drawings in detailed description, wherein like reference numerals represent like parts.

FIG. 1 illustrates a telecommunications network element according to an embodiment of the present disclosure.

FIG. 2 illustrates a method for invoking a service on a network element according to an embodiment of the present disclosure.

### DETAILED DESCRIPTION OF THE PREFERRED EMBODIMENTS

It should be understood at the outset that although an exemplary implementation of one embodiment of the present invention is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

The services on a network element typically undergo a configuration process to enable communication with one another. Under the prior art, configuration of the services is typically achieved through cumbersome and elaborate programming practices. When a network element is first deployed, the services on the network element might not know which other services are present on the network element. In such a case, a service may need to be programmed to be able to communicate with all other services that might potentially be present on the network element. A large number of “if” statements or similar programming techniques might be hard coded into a network element's software so that services on the network element can determine which other services are present and can communicate with the other services. Configuring the services on a network element in this manner can be cumbersome and wasteful since a service typically needs to be hard coded with the capability to communicate with other services with which it may never actually communicate.

In an alternative of the prior art, the specific services that will be installed on a network element might be known prior to the deployment of the network element. In this case, each service might be custom built to communicate with the specific other services known to be present on a network element. Configuring the services on a network element in this manner can be costly since each service typically needs to be hard coded with the appropriate communication capabilities. In either of the above cases, the hard coding of the messaging software can lead to highly complex code that is inflexible and difficult to maintain.

In an embodiment of the present disclosure, a service-oriented architecture is used to manage the messaging between services in a network element. In the service-oriented architecture, much of the major software functionality in a network element is structured as services. Each service has a defined interface that is invoked by clients desiring the service. The interface is typically standardized for platform independent communications. Each invocation of a service is independent of all other interactions. This approach results in the services being loosely coupled and provides a significant advantage due to reuse potential and overall flexibility of the software structure.

Various service-oriented architectures currently exist, for example in the field of web services. However, these protocols, such as Universal Description, Discovery, and Integration (UDDI) and Web Service Description Language (WSDL), tend to be complex and heavyweight. Service-oriented architectures such as these are thus typically not appropriate for use in a network element, where processing power and memory capacity tend to be limited.

Embodiments of the present disclosure use a lightweight messaging framework consisting of only six messages, however in other embodiments other numbers of messages may be used. This service-oriented architecture minimizes the messaging overhead for service registration, discovery, and invocation. This architecture also allows easy software maintenance, provides an easy to understand programming paradigm, and enables more advanced capabilities such as graceful software upgrades and plug-and-play features. The lightweight messaging framework allows this service-oriented architecture to be implemented on network elements with limited processing power and memory capacity.

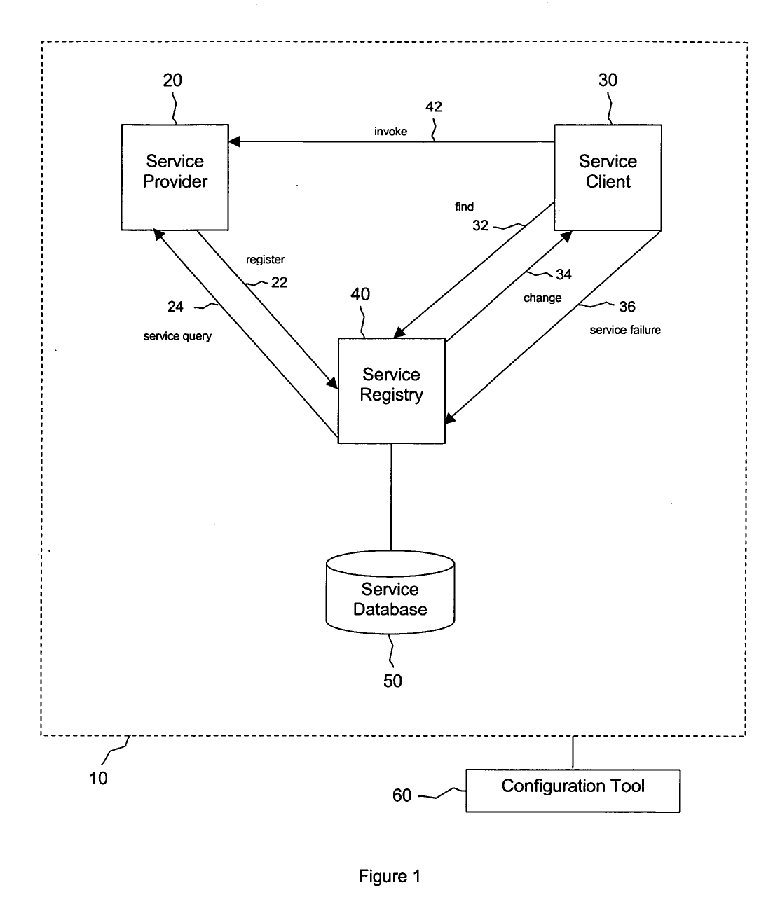

FIG. 1 illustrates an embodiment of a network element 10 that uses this service-oriented architecture. The network element 10 contains a service provider 20, a service client 30, and a service registry 40. While only one service provider 20 and one service client 30 are shown, a plurality of service providers and service clients would typically be present. Also, other components may be present in the network element 10 but are not shown.

The service registry 40 is a data repository that stores information about the services provided by the network element 10. The information that is stored might include which services are currently configured, the service names and versions numbers, the locations of the services (such as an IP address and a port number), the messages required to invoke the services, whether or not the services will provide a response, and a timeout value for responses. The service registry 40 might store this information internally or might store the information externally in a service database 50, which might be a relational database, a directory, or some other type of data storage medium. While the service database 50 is shown internal to the network element 10, in other embodiments the service database 50 may be external to the network element 10.

The service provider 20 is a software component that contains service execution code. The service provider 20 registers its service with the service registry 40 so that service clients 30 can find the service provider 20 and invoke its service. The service client 30 is a software component that can find and invoke a service from the service provider 20 based on information obtained from the service registry 40. A service provider 20 and a service client 30 can coexist within the same software component.

Different network elements 10 might provide different services. For example, one set of services might be applicable to a base station and another set of services might be applicable to an IP switch. In an embodiment, a configuration tool 60 is used to load a set of services onto a network element 10. An operator might use the configuration tool 60 to select a set of services that are needed by a network element 10 and the configuration tool 60 might load the selected services onto the network element 10. The loaded services might then register themselves, as described below, so that the services are available for service clients 30.

In an embodiment, six messages are used for communication among the service provider 20, the service client 30, and the service registry 40: a register message 22, a find message 32, an invoke message 42, a change message 34, a service failure message 36, and a service query message 24. In an embodiment, the messages are encoded in the XML programming language. The use of XML allows a limited set of variables to be defined that specify only the parameters known to be needed for communication among the service provider 20, the service client 30, and the service registry 40. This can be contrasted with the prior art where a large number of variables might be needed to deal with all possible parameters that might arise during communication within a network element. In other embodiments, other programming languages that provide similar capabilities might be used.

A service provider 20 can publish its service or services to the service registry 40 using a register message 22. The service registry 40 extracts data attributes from this message and updates the service database 50 with the data. The following is an example of XML code that could be used to encode a register message 22. Values for programming variable fields are in italics.

<Msg>

<Hdr>

<RespMsgBaseId>response_msg_id</RespMsgBaseId>

</Hdr>
<Payload>

<SvcName>service_name</SvcName>
<Version>version_num</Version>
<Ip>ip_addr</Ip>
<Port>port_num</Port>
<MsgId>msg_id</MsgId>
<Resp>resp_flag</Resp>
<WaitTime>wait_time</WaitTime>
<MultiPayload>multi_payload</MultiPayload>

</Payload>

</Msg>

The response_msg_id field is used to map the register message 22 to a response from the service registry 40. The service_name field is the name of the service being registered. The version_num field is the version number of the service. The ip_addr field is the service provider IP address for subsequent invocation. The port_num field is the service provider port number for subsequent invocation. The msg_id field is the message ID that needs to be used when invoking the service. The resp_flag field identifies whether the service provider 20 will send a response to the service client 30. The wait_time field specifies the length of time the service client 30 should wait for a response from the service provider 20 before the service client 30 begins its failure logic. The multi_payload field specifies whether the service provider 20 can handle multiple payloads within the invocation. In other embodiments, other names of the fields could be used and other fields could be present.

Upon receiving a register message 22, the service registry 40 sends a response to the service provider 20 indicating the success or failure of the service registration. The response to the register message 22 can be identical to the register message 22 but with one addition. The response message might contain a field in the header portion to indicate the success or failure of the registration. For the sake of clarity in the drawing, the response to the register message 22 is not shown in FIG. 1. The responses to the other messages described below are also not illustrated.

When a service client 30 needs to find a service, the service client 30 sends a find message 32 to the service registry 40. The find message 32 contains parameters that the service registry 40 can use in its search of the service database 50 for the location of the appropriate service provider 20. The following is an example of XML code that could be used to encode a find message 32. Values for programming variable fields are in italics.

<Msg>

<Hdr>

<RespMsgBaseId>response_msg_id</RespMsgBaseId>

</Hdr>
<Payload>

<SvcName>service_name</SvcName>
<Update>update_flag</Update>

</Payload>

</Msg>

The response_msg_id field is used to map the find message 32 to a response from the service registry 40. The service_name field is the name of the service that the service client 30 wishes to find. The update_flag field specifies whether the service client 30 is interested in future updates to the service. In other embodiments, other names of the fields could be used and other fields could be present.

After searching the service database 50 for the location of the requested service, the service registry 40 sends a response to the service client 30 indicating the success or failure of the service find operation. In an embodiment, the response to a find message 32 is substantially similar to the response to a register message 22 described above.

When a service client 30 is ready to invoke a registered service, the service client 30 uses the location of the appropriate service provider 20 that was returned from the service registry 40 in response to a find message 32. The service of the service provider 20 is invoked and executed via an invoke message 42. In an embodiment, the message used to invoke a service is specific to each application. A header portion of the invoke message 42 might identify the service to be invoked, the command to be executed, and additional information to further specify the service. A data portion of the invoke message 42 might include indices and additional information required as application-specific parameters. The following is an example of XML code that could be used to encode an invoke message 42.

<Request>

<Hdr>

<SvcName>CmCore</SvcName>
<CmdType>Retrieve</CmdType>
<AdditionalInfo>BTS</Additional Info>

</Hdr>
<Data>

<Index Name=“BTS”>1</Index>
<Var Name=“BTSConf::param1”></Var>

</Data>

</Request>

The response to an invoke message 42 contains the output and status associated with the service invocation. It will be appreciated that, in some embodiments, the response to the invoke message 42, or perhaps responses to other messages as well, may be optional and no response may be required or used. Responses to service invocations are also specific to each application. An example service invocation response for the above message is shown below. The application-specific response contains an additional field (ErrorCode) and the value of the service invocation (“91”)<

<Response>

<SvcHdr>

<SvcName>CmCore</SvcName>
<CmdType>Retrieve</CmdType>
<AdditionalInfo>BTS</Additional Info>
<ErrorCode>COMPLD</ErrorCode>

</SvcHdr>
<Data>

<Index Name=“BTS”>1</Index>
<Var Name=“BTSConf::param1”>91</Var>

</Data>

</Response>

In an embodiment, the service registry 40 maintains an internal notification list of service clients 30 interested in receiving service update notifications. Interest in the update notifications is indicated by the value of the update_flag variable in the find messages 32 previously sent from the service clients 30 to the service registry 40. When a registered service experiences a change (such as a new IP address, an exception crash, or a new version), the service provider 20 providing the service registers again with the service registry 40 as described above. The service registry 40 then uses a change message 34 to the inform service clients 30 on the notification list of the change. This approach allows the service clients 30 to gracefully re-establish communication with a service provider 20 that has experienced a change.

In an embodiment, the format of a change message 34 is substantially similar to the format of a register message 22 described above. The only difference is that a register message 22 is sent from a service provider 20 to the service registry 40, while a change message 34 is sent from the service registry 40 to service clients 30 that are interested in the change message 34.

The service registry 40 additionally provides a basic service monitoring capability that includes a service failure message 36 and a service query message 24. When a service invocation fails, the service client 30 that made the failed invocation informs the service registry 40 of the invocation failure by means of a service failure message 36. The service registry 40 then uses a service query message 24 to query the service provider 20 to which the failed invocation was sent. The service query message 24 attempts to ascertain the status of the service provider 20. The following is an example of XML code that could be used to encode a service failure message 36. Values for programming variable fields are in italics.

<Msg>

</Hdr>
<Payload>

<SvcName>service_name</SvcName>

</Payload>

</Msg>

The service_name field contains the name of the service that has apparently failed. In other embodiments, other names could be used for the field and other fields could be present. In an embodiment, there is no response to a service failure message 36 and no header is used in a service failure message 36.

Upon receipt of a service failure message 36, the service registry 40 uses a service query message 24 to query the service provider 20 that has apparently failed. The service query message 24 is sent to the last known location for the service provider 20. In an embodiment, the format of a service query message 24 is substantially similar to the format of a service failure message 36, except that, for the service query message 24, the service_name field contains the name of the service that is being queried.

Upon receipt of a service query message 24, a service provider 20 responds with a service query response message if the service is up and running. In an embodiment, the service query response message format is identical to the format of a register message 22 described above, except that the service query response message has no header.

It should be understood that the programming code samples quoted above are examples only and that other coding techniques or syntax could be used to achieve similar functionality. Also, other names could be used for the messages and variables described above. In addition, while the code samples are written in the XML programming language, other languages that provide similar capabilities could be used.

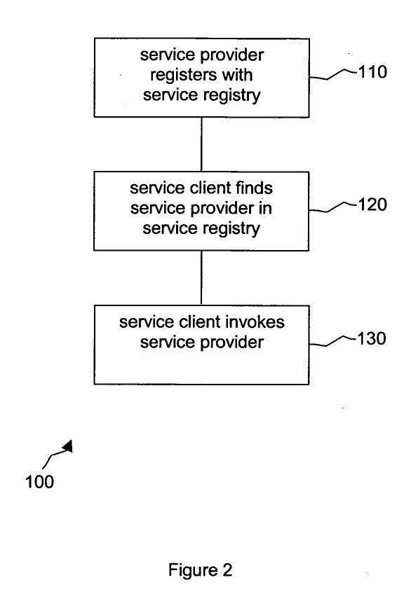

FIG. 2 illustrates a method 100 for invoking a service on a network element. In box 110, a service provider within the network element registers with a service registry within the network element. The registration might consist of the service provider informing the service registry of the services it provides and its location, such as an IP address or a port number. In box 120, a service client within the network element informs the service registry of a service that it wishes to invoke. The service registry finds the name and location of the service provider that provides the service and returns the name and location to the service client. In box 130, the service client invokes the service on the service provider using the name and location returned by the service registry.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A telecommunications network element comprising:
a plurality of software components configured to communicate with one another in a service-oriented architecture.

2. The network element of claim 1, wherein the service-oriented architecture comprises:
a service provider;
a service client;
a service registry; and
a plurality of messages including a first message operable for the service provider to register with the service registry, a second message to allow the service client to use the service registry to locate for communication with the service provider, and a third message operable for the service client to invoke a service of the service provider.

3. The network element of claim 1, wherein the service-oriented architecture comprises:
a service provider;
a service client;
a service registry; and
a plurality of messages including:
a register message operable for the service provider to register with the service registry, including providing the location of the service provider, the service of the service provider, and to register a change in the service provided by the service provider,
a find message operable for the service client to determine the location of the service in the service registry,
an invoke message operable for the service client to invoke the service using the location found in the service registry,
a change message operable for the service registry to inform the service client of a change in a service provided by the service provider,
a service failure message operable for the service client to inform the service registry of a failure of an invocation to the service provider, and
a service query message operable to allow the service registry to attempt to ascertain the status of the service provider upon the failure of an invocation to the service provider.

4. The network element of claim 3, wherein the register message is sent from the service provider to the service registry and includes:
a field containing an identifier that maps the register message to a response to the register message;
a field specifying a name of a service the service provider provides;
a field specifying a version number of a service the service provider provides;
a field specifying a location of a service the service provider provides;
a field specifying an invoke message to be used to invoke a service the service provider provides;
a field specifying whether the service provider sends a response to the service client; and
a field specifying a length of time the service client will wait for a response from the service provider before initiating a failure procedure.

5. The network element of claim 3, wherein the find message includes:
a field containing an identifier that maps the find message to a response to the find message;
a field specifying a name of a service to be found; and
a field specifying whether the service client wishes to be notified of a change to the service provider.

6. The network element of claim 3, wherein the invoke message includes:
a field specifying a service to be invoked; and
a field specifying a command to be executed.

7. The network element of claim 3, wherein the change message is sent from the service registry to the service client when a change occurs in the service provider and the find message indicates that the service client should to be notified of a change to the service provider and wherein the change message includes:
a field containing an identifier that maps the change message to a response to the change message;
a field specifying a name of a service the service provider provides;
a field specifying a version number of a service the service provider provides;
a field specifying a location of a service the service provider provides;
a field specifying an invoke message to be used to invoke a service the service provider provides;
a field specifying whether the service provider sends a response to the service client; and
a field specifying a length of time the service client will wait for a response from the service provider before initiating a failure procedure.

8. The network element of claim 3, wherein the service failure message includes a field specifying a service that failed.

9. The network element of claim 3, wherein the service query message includes a field specifying a service being queried.

10. The network element of claim 3, wherein the messages are encoded in the XML programming language.

11. A method for invoking a service on a network element comprising:
a service provider on the network element informing a service registry on the network element of a service provided by the service provider and a location for communication with the service provider;
a service client on the network element obtaining the location of the service provider in the service registry; and
the service client invoking a service provided by the service provider using the location of the service provider found in the service registry.

12. The method of claim 11, further comprising the service provider informing the service registry of a change in service provided by the service provider.

13. The method of claim 12, further comprising the service registry maintaining a list of service clients to be notified when a change occurs in service provided by the service provider.

14. The method of claim 13, further comprising, when a change occurs in service provided by the service provider, the service registry notifying the service clients on the list of the change.

15. The method of claim 1, further comprising, when the invocation from the service client to the service provider fails, the service client notifying the service registry of the failure.

16. The method of claim 15, further comprising, when the service registry is notified of the failure, the service registry querying the service provider to attempt to ascertain the status of the service provider.

17. A network element comprising:
a service provider operable to provide a service and to send a register message to register the service, the register message including a service provided by the service provider and an identifier for use to communicate with the service provider to invoke the service;
a service registry operable to receive and store and register message from the service provider; and
a service client operable to send a find message to locate the identifier of the service provider in the service registry and to send an invoke message to invoke the service of the service provider.

18. The system of claim 17, wherein the network element is selected from a group consisting of a mobile switching center, a base station, a radio station, a controller, an access point, a core switch, a gateway, a mobile station, and a mobile handset.

19. The system of claim 17, wherein the messages further include:
a change message operable to allow the service registry to inform the service client of a change in a service provided by the service provider;
a service failure message operable to allow the service client to inform the service registry of a failure of an invocation to the service provider; and
a service query message operable to allow the service registry to attempt to ascertain the status of the service provider upon the failure of an invocation to the service provider.

20. The system of claim 19, further comprising:
a service database in which the service registry can store information and from which the service registry can retrieve information regarding the service the service provider provides and the location of the service provider; and
at least one response message related to one or more of the messages.
